(19) United States
(12) Patent Application Publication
(10) Pub. No.: US 2014/0084897 A1
(43) Pub. Date: Mar. 27, 2014

(54) Current Detection Device and Buck-Boost DC-DC Converter Using the Same

(71) Applicant: ENERGY PASS INCORPORATION, Hsinchu City (TW)

(72) Inventors: Meng-Yin Liao, Yunlin County (TW); Chao-Hsuan Liu, New Taipei City (TW); Ying-Che Lo, Tainan City (TW)

(73) Assignee: ENERGY PASS INCORPORATION, Hsinchu City (TW)

(21) Appl. No.: 13/628,052

(22) Filed: Sep. 27, 2012

(51) Int. Cl. G05F 3/08

(52) U.S. Cl. 323/311

(57) ABSTRACT

A current detection device for a buck-boost DC-DC converter is disclosed. The current detection device comprises a detecting terminal coupled to two low-side transistors of the buck-boost DC-DC converter, and only one current sensing unit for detecting a current flowing through the detecting terminal, to detect an output current of the buck-boost DC-DC converter.

### BACKGROUND OF THE INVENTION

1. Field of the Invention

The present invention relates to a current detection device and a buck-boost DC-DC converter using the same, and more particularly, to a current detection device and a buck-boost DC-DC converter capable of detecting an output current of the buck-boost DC-DC converter with only one current sensing unit, to save circuit area and cost.

2. Description of the Prior Art

DC-DC converters are widely utilized in power management systems. In general, the DC-DC converters can be classified to three types: buck converter, boost converter, and buck-boost converter. A buck converter is a DC-DC converter with the output voltage lower than the input voltage, a boost converter is a DC-DC converter with the output voltage higher than the input voltage, and a buck-boost converter is a DC-DC converter wherein the output voltage may be higher or lower than the input voltage. Therefore, the buck-boost converter may become a preferable choice due to flexibility of a range of the output voltage.

However, the buck-boost converter needs more transistors in the output stage to realize a wide range of the output voltage. Several circuits in the output stage may also be enlarged and complicated correspondingly. For example, please refer to FIG. 1A, which is a schematic diagram of a conventional output stage 100 of a synchronous buck-boost converter. As shown in FIG. 1A, the output stage 100 includes a high-side transistor 102, two low-side transistors 104, 106, a pass transistor 108, an inductor L1, an output capacitor C1, and two voltage-dividing resistors R1, R2. The output stage 100 of the synchronous buck-boost converter has four transistors, in comparison with an output stage of a buck converter or a boost converter, which has only two transistors. Besides, as shown in FIG. 1A, the output stage 100 further includes two sensing resistors Ra, Rb for output current detection, wherein the sensing resistor Ra is coupled to the low-side transistor 104, and the sensing resistor Rb is coupled to the low-side transistor 106.

Please refer to FIG. 1B, which is a schematic diagram of a conventional output stage 150 of an asynchronous buck-boost converter. The output stage 150 is similar to the output stage 100, and hence the same elements are denoted by the same symbols. The main difference between the output stage 150 and the output stage 100 is that in the output stage 150, the low-side transistor 104 and the pass transistor 108 are replaced by a low-side diode 154 and a pass diode 158, respectively. Similarly, as shown in FIG. 1B, the output stage 150 also includes two sensing resistors Ra, Rb for output current detection, wherein the sensing resistors Ra is coupled to the low-side diode 154, and the sensing resistor Rb is coupled to the low-side transistor 106.

As shown in FIG. 1A and FIG. 1B, the output stages 100, 150 are both implemented with two sensing resistors for output current detection indifferent operation modes, and the buck-boost converter may require two current detection devices accordingly, which may be redundant for only one output current in each of the output stages 100, 150. Thus, there is a need for improvement of the prior art.

### SUMMARY OF THE INVENTION

It is therefore an objective of the present invention to provide a current detection device and a buck-boost DC-DC converter using the same capable of detecting an output current of the buck-boost DC-DC converter with only one current sensing unit, to save circuit area and cost.

The present invention discloses a current detection device for a buck-boost DC-DC converter. The current detection device comprises a detecting terminal coupled to two low-side transistors of the buck-boost DC-DC converter, and only one current sensing unit for detecting a current flowing through the detecting terminal, to detect an output current of the buck-boost DC-DC converter.

The present invention further discloses a current detection method for a buck-boost DC-DC converter. The method comprises disposing a detecting terminal coupled to two low-side transistors of the buck-boost DC-DC converter, and detecting a current flowing through the detecting terminal with only one current sensing unit, to detect an output current of the buck-boost DC-DC converter.

The present invention further discloses a buck-boost DC-DC converter. The buck-boost DC-DC converter comprises a high-side transistor for providing the output current, two low-side transistors for sinking the output current, a pass transistor for passing the output current to an output node, an inductor coupled between the high-side transistor, the two low-side transistors, and the pass transistor, for passing through the output current, an output capacitor coupled to the pass transistor, a detecting terminal coupled to the two low-side transistors of the buck-boost DC-DC converter; and only one current sensing unit for detecting a current flowing through the detecting terminal, to detect an output current of the buck-boost DC-DC converter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a conventional output stage of a synchronous buck-boost converter.

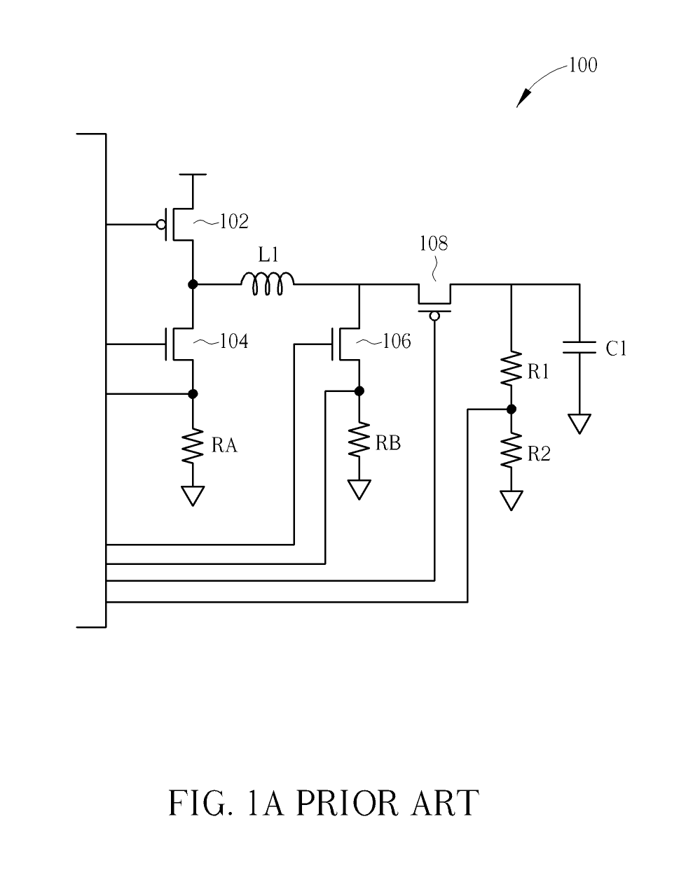

FIG. 1B is a schematic diagram of a conventional output stage of an asynchronous buck-boost converter.

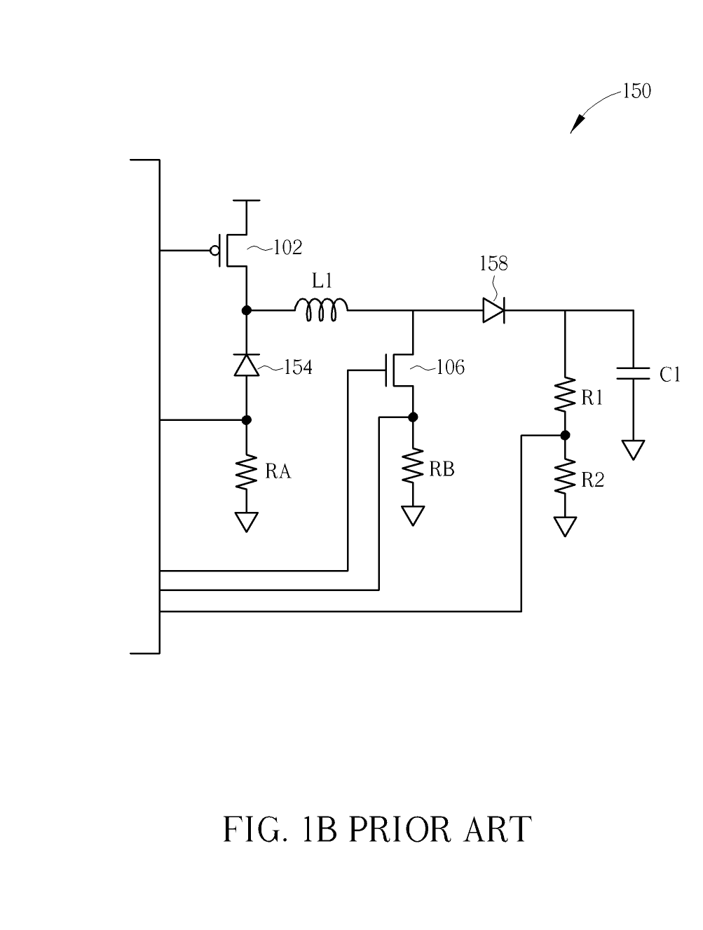

FIG. 2A is a schematic diagram of an output stage of a synchronous buck-boost converter according to an embodiment of the present invention.

FIG. 2B is a schematic diagram of an output stage of an asynchronous buck-boost converter according to an embodiment of the present invention.

FIG. 3A is a schematic diagram of the output stage shown in FIG. 2A operated as a buck converter according to an embodiment of the present invention.

FIG. 3B is a schematic diagram of the output stage shown in FIG. 2B operated as a buck converter according to an embodiment of the present invention.

FIG. 4A is a schematic diagram of the output stage shown in FIG. 2A operated as a boost converter according to an embodiment of the present invention.

FIG. 4B is a schematic diagram of the output stage shown in FIG. 2B operated as a boost converter according to an embodiment of the present invention.

### DETAILED DESCRIPTION

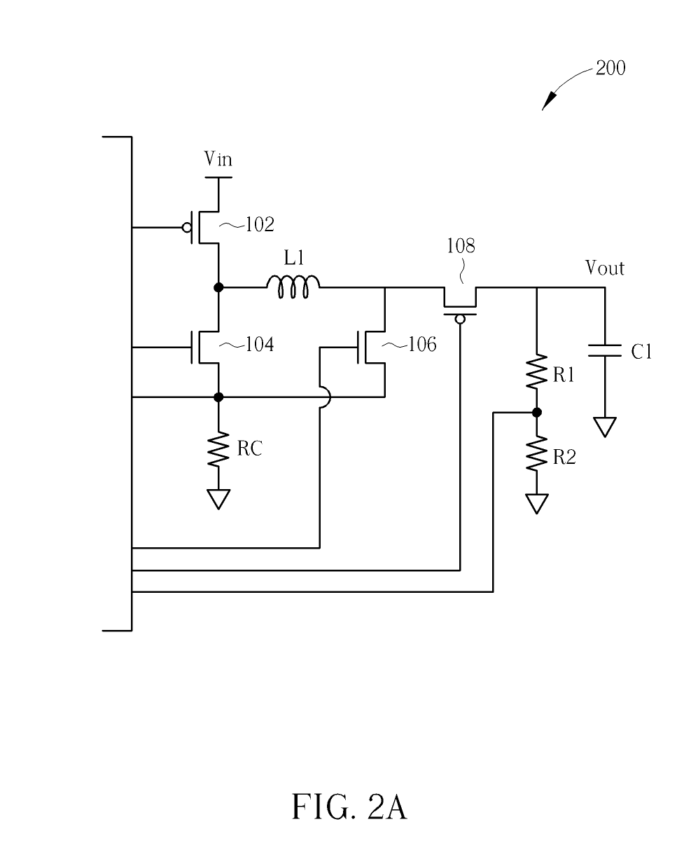

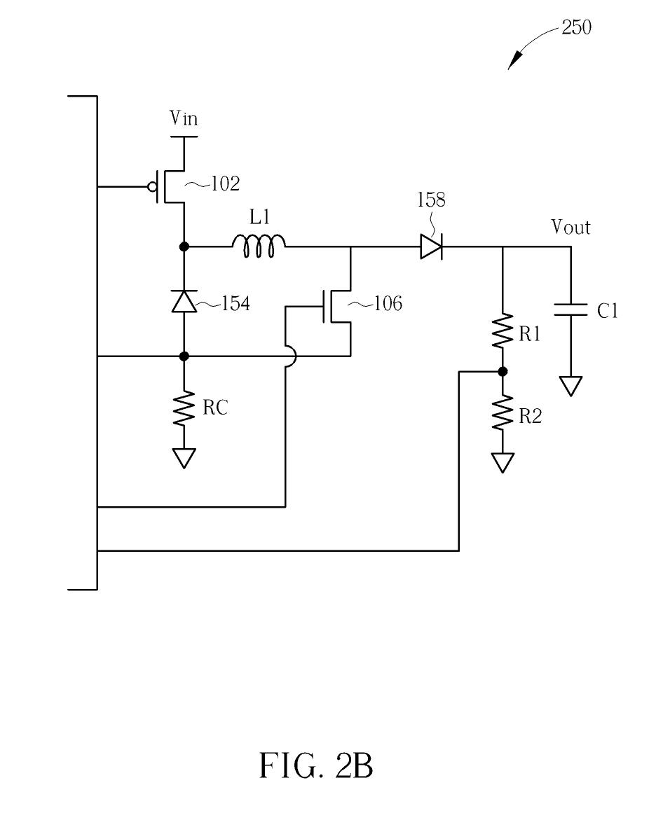

Please refer to FIG. 2A, which is a schematic diagram of an output stage 200 of a synchronous buck-boost converter according to an embodiment of the present invention. As shown in FIG. 2A, the output stage 200 is similar to the output stage 100, and hence the same elements are denoted by the same symbols. The main difference between the output stage 200 and the output stage 100 is that the output stage 100 has two sensing resistors RA, RB coupled to the low-side transistors 104, 106, respectively, and the output stage 200 has only one sensing resistor RC coupled to both of the low-side transistors 104, 106. In such a condition, the output stage 200 utilizes only one sensing resistor RC to replace the function of two sensing resistors RA, RB in the output stage 100, and thus only one detecting terminal is required. Therefore, area and cost of the sensing resistor in the output stage 200 may be reduced by half, and in addition, circuit area and cost of the current detection device in the output stage 200 may also be reduced by half.

Please refer to FIG. 2B, which is a schematic diagram of an output stage 250 of an asynchronous buck-boost converter according to an embodiment of the present invention. As shown in FIG. 2B, the output stage 250 is similar to the output stage 150, and hence the same elements are denoted by the same symbols. The main difference between the output stage 250 and the output stage 150 is that the output stage 150 has two sensing resistors RA, RB coupled to the low-side diode 154 and the low-side transistor 106, respectively, and the output stage 250 has only one sensing resistor RC coupled to both the low-side diode 154 and the low-side transistor 106. In such a condition, the output stage 250 utilizes only one sensing resistor RC to replace the function of two sensing resistors RA, RB in the output stage 150, and thus only one detecting terminal is required. Therefore, area and cost of the sensing resistor in the output stage 250 may be reduced by half, and in addition, circuit area and cost of the current detection device in the output stage 250 may also be reduced by half.

In detail, the buck-boost converter possesses functions of the buck converter and the boost converter simultaneously, that is, in FIG. 2A and FIG. 2B, an output voltage Vout can be higher or lower than an input voltage Vin. If the output voltage Vout is lower than the input voltage Vin, the output stages 200, 250 of the buck-boost converters are operated as buck converters; if the output voltage Vout is higher than the input voltage Vin, the output stages 200, 250 of the buck-boost converters 200, 250 are operated as boost converters.

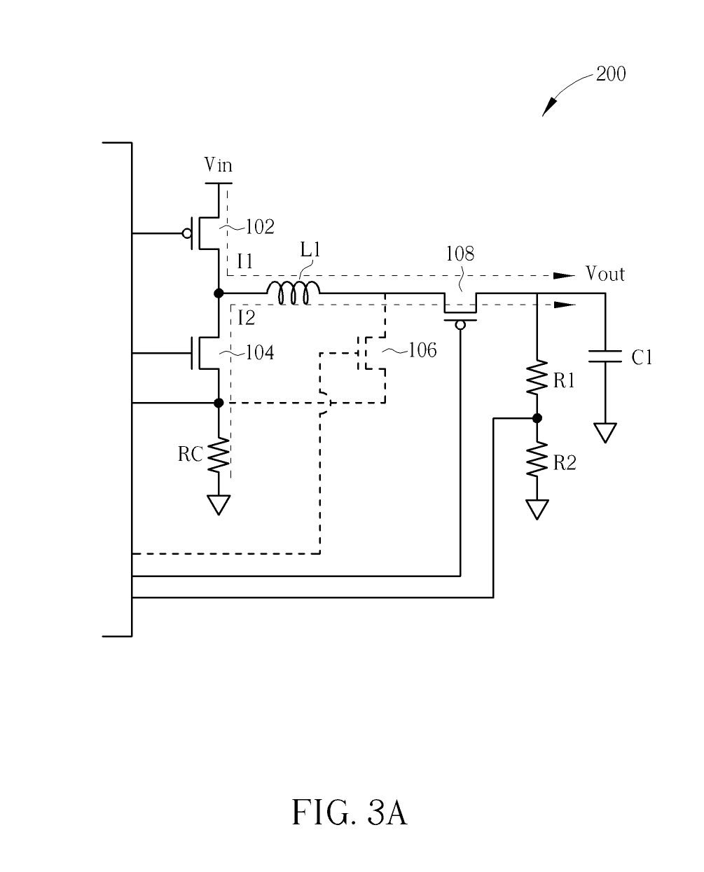

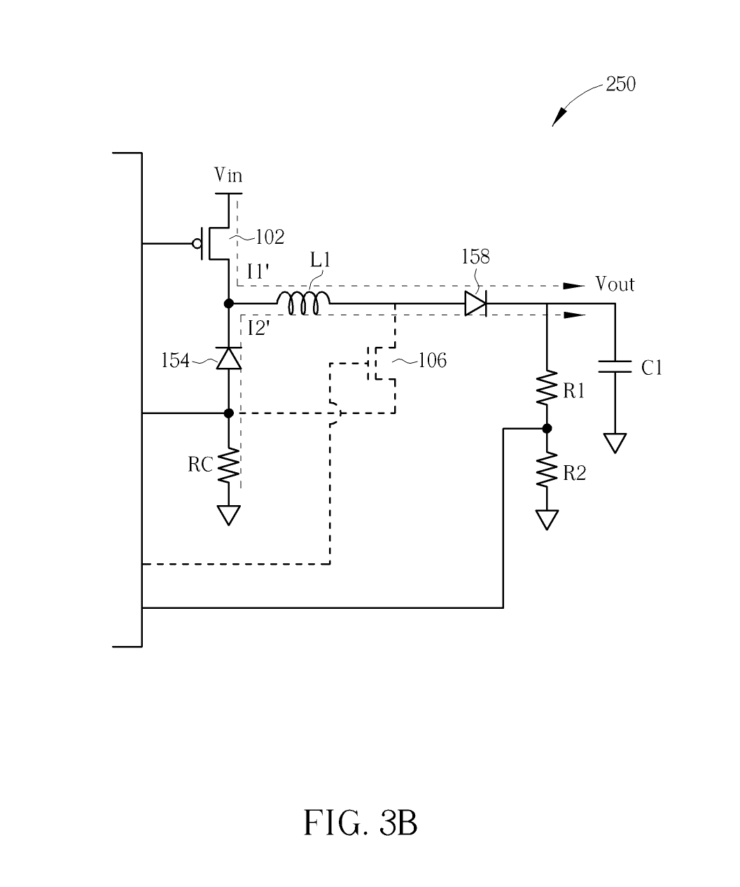

Please refer to FIG. 3A, which is a schematic diagram of the output stage 200 shown in FIG. 2A operated as a buck converter according to an embodiment of the present invention. In general, a buck-boost converter operated as a buck converter may possess two operation modes. In both operation modes, the low-side transistor 106 is always turned off, and thus plotted with dotted line, as shown in FIG. 3A. In one operation mode, the high-side transistor 102 is turned on, the low-side transistor 104 is turned off, and the pass transistor 108 is turned on. In such a condition, current I1 flows from the input terminal through the high-side transistor 102, the inductor L1, and the pass transistor 108 to the output terminal, to charge the output voltage Vout with the input voltage Vin. In the other operation mode, the high-side transistor 102 is turned off, the low-side transistor 104 is turned on, and the pass transistor 108 is turned on. In such a condition, current I2 flows from ground terminal through the low-side transistor 104, the inductor L1, and the pass transistor 108 to the output terminal, to discharge the output voltage Vout. Therefore, the sensing resistor RC can detect the current I2 in this operation mode.

Please refer to FIG. 3B, which is a schematic diagram of the output stage 250 shown in FIG. 2B operated as a buck converter according to an embodiment of the present invention. In general, a buck-boost converter operated as a buck converter may possess two operation modes. In both operation modes, the low-side transistor 106 is always turned off, and thus plotted with dotted line, as shown in FIG. 3B. In one operation mode, the high-side transistor 102 is turned on, the low-side diode 154 is reverse biased, and the pass diode 158 is forward biased. In such a condition, current I1′ flows from the input terminal through the high-side transistor 102, the inductor L1, and the pass diode 158 to the output terminal, to charge the output voltage Vout with the input voltage Vin. In the other operation mode, the high-side transistor 102 is turned off, the low-side diode 154 is forward biased, and the pass diode 158 is forward biased. In such a condition, current I2′ flows from ground terminal through the low-side diode 154, the inductor L1, and the pass diode 158 to the output terminal, to discharge the output voltage Vout. Therefore, the sensing resistor RC can detect the current I2′ in this operation mode.

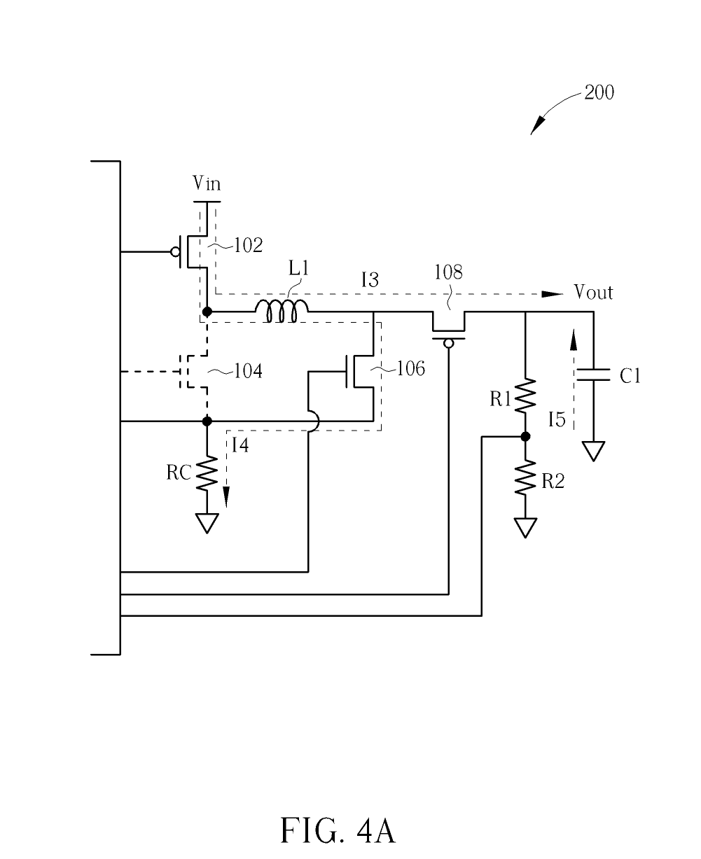

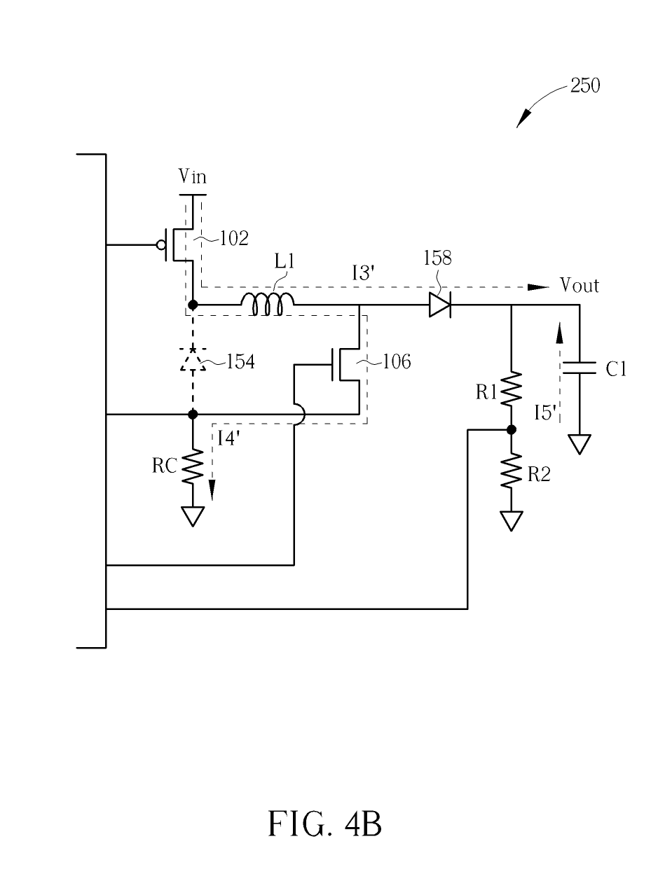

Please refer to FIG. 4A, which is a schematic diagram of the output stage 200 shown in FIG. 2A operated as a boost converter according to an embodiment of the present invention. In general, a buck-boost converter operated as a boost converter may possess two operation modes. In both operation modes, the low-side transistor 104 is always turned off, and thus plotted with dotted line, as shown in FIG. 4A. In one operation mode, the high-side transistor 102 is turned on, the low-side transistor 106 is turned off, and the pass transistor 108 is turned on. In such a condition, current I3 flows from the input terminal through the high-side transistor 102, the inductor L1, and the pass transistor 108 to the output terminal, to charge the output voltage Vout with the input voltage Vin. In the other operation mode, the high-side transistor 102 is turned on, the low-side transistor 106 is turned on, and the pass transistor 108 is turned off. In such a condition, current I4 flows from the input terminal through the high-side transistor 102, the inductor L1, and the low-side transistor 106 to ground terminal, and another current I5 flows from the capacitor C1 to the output terminal, to further charge the output voltage Vout. Therefore, the sensing resistor RC can detect the current 14 in this operation mode.

Please refer to FIG. 4B, which is a schematic diagram of the output stage 250 shown in FIG. 2B operated as a boost converter according to an embodiment of the present invention. In general, a buck-boost converter operated as a boost converter may possess two operation modes. In both operation modes, the low-side diode 154 is always reverse biased, and thus plotted with dotted line, as shown in FIG. 4B. In one operation mode, the high-side transistor 102 is turned on, the low-side transistor 106 is turned off, and the pass diode 158 is forward biased. In such a condition, current I3′ flows from the input terminal through the high-side transistor 102, the inductor L1, and the pass diode 158 to the output terminal, to charge the output voltage Vout with the input voltage Vin. In the other operation mode, the high-side transistor 102 is turned on, the low-side transistor 106 is turned on, and the pass diode 158 is reverse biased. In such a condition, current I4′ flows from the input terminal through the high-side transistor 102, the inductor L1, and the low-side transistor 106 to ground terminal, and another current I5′ flows from the capacitor C1 to the output terminal, to further charge the output voltage Vout. Therefore, the sensing resistor RC can detect the current I4′ in this operation mode.

Please note that, the embodiments of the present invention are to detect an output current of the buck-boost converter with only one current sensing unit, to save circuit area and cost . Those skilled in the art can make modifications or alterations accordingly. For example, the transistors 102, 104, 106 and 108 in the output stage 200 and the transistors 102 and 106 in the output stage 250 are all MOS transistors, but in other embodiments, these transistors may also be replaced by bipolar junction transistors (BJTs), which is not limited herein. Besides, in the above embodiments, the resistor RC is utilized for output current detection, but in other embodiments, other methods (e.g. current mirror) can also be utilized for output current detection, which is not limited herein. In general, output current detection is performed for over-current protection, but in some embodiments, output current detection may be performed for other purposes, which is not limited herein.

In the prior art, the output stage of a buck-boost converter is implemented with two sensing resistors for output current detection in different operation modes, and the buck-boost converter may require two current detection devices accordingly, which may be redundant for only one output current. In comparison, the present invention detects an output current of the buck-boost converter with only one resistor and only one current detection device accordingly, to save circuit area and cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A current detection device for a buck-boost DC-DC converter, comprising:
a detecting terminal, coupled to two low-side transistors of the buck-boost DC-DC converter; and
only one current sensing unit, for detecting a current flowing through the detecting terminal, to detect an output current of the buck-boost DC-DC converter.

2. The current detection device of claim 1, wherein the only one current sensing unit detects the output current of the buck-boost DC-DC converter for over-current protection.

3. The current detection device of claim 1, wherein the only one current sensing unit comprises only one resistor, coupled to the detecting terminal, for detecting the current flowing through the detecting terminal.

4. The current detection device of claim 1, wherein the buck-boost DC-DC converter is a synchronous buck-boost DC-DC converter.

5. The current detection device of claim 1, wherein the buck-boost DC-DC converter is an asynchronous buck-boost DC-DC converter.

6. A current detection method for a buck-boost DC-DC converter, comprising:
disposing a detecting terminal coupled to two low-side transistors of the buck-boost DC-DC converter; and
detecting a current flowing through the detecting terminal with only one current sensing unit, to detect an output current of the buck-boost DC-DC converter.

7. The method of claim 6, wherein the only one current sensing unit detects the output current of the buck-boost DC-DC converter for over-current protection.

8. The method of claim 6, wherein the only one current sensing unit comprises only one resistor for detecting the current flowing through the detecting terminal.

9. The method of claim 6, wherein the buck-boost DC-DC converter is a synchronous buck-boost DC-DC converter.

10. The method of claim 6, wherein the buck-boost DC-DC converter is an asynchronous buck-boost DC-DC converter.

11. A buck-boost DC-DC converter, comprising:
a high-side transistor, for providing the output current;
two low-side transistors, for sinking the output current;
a pass transistor, for passing the output current to an output node;
an inductor, coupled between the high-side transistor, the two low-side transistors, and the pass transistor, for passing through the output current;
an output capacitor, coupled to the pass transistor;
a detecting terminal, coupled to the two low-side transistors of the buck-boost DC-DC converter; and
only one current sensing unit, for detecting a current flowing through the detecting terminal, to detect an output current of the buck-boost DC-DC converter.

12. The buck-boost DC-DC converter of claim 11, wherein the only one current sensing unit detects the output current of the buck-boost DC-DC converter for over-current protection.

13. The buck-boost DC-DC converter of claim 11, wherein the only one current sensing unit comprises only one resistor, coupled to the detecting terminal, for detecting the current flowing through the detecting terminal.

14. The buck-boost DC-DC converter of claim 11, wherein the only one current sensing unit comprises only one resistor, coupled to the two low-side transistors, for detecting the current flowing through both of the two low-side transistors.

15. The buck-boost DC-DC converter of claim 11, wherein the buck-boost DC-DC converter is a synchronous buck-boost DC-DC converter.

16. The buck-boost DC-DC converter of claim 11, wherein the buck-boost DC-DC converter is an asynchronous buck-boost DC-DC converter.
